(19) United States
(12) Patent Application Publication
(10) Pub. No.: US 2025/0294535 A1
(43) Pub. Date: Sep. 18, 2025

(54) BANDWIDTH AGGREGATION CONFIGURATION FOR FRACTIONAL SPECTRUM INTEGRATION

(71) Applicant: QUALCOMM Incorporated, San Diego, CA (US)

(72) Inventors: Jing LEI, San Diego, CA (US); Kazuki TAKEDA, Minato-ku (JP); Heechoon LEE, San Diego, CA (US)

(21) Appl. No.: 18/605,152

(22) Filed: Mar. 14, 2024

(51) Int. Cl. H04W 72/0453; H04L 5/00; H04W 72/12; H04W 72/20

(52) U.S. Cl. CPC H04W 72/0453; H04L 5/001; H04W 72/12; H04W 72/20

(57) ABSTRACT

Methods, systems, and devices for wireless communications are described. A network entity may configure a virtual cell for communication with a user equipment (UE) in accordance with a set of bandwidth aggregation states of the virtual cell. A bandwidth aggregation state may indicate a quantity of subband groups configured for the virtual cell, a frequency range of aggregated bandwidth supported by the virtual cell, a quantity of subbands within each subband group, and a frequency separation between adjacent subbands in the subband group. In some examples, a UE may transmit capability signaling to indicate to the network entity a subset of the set of bandwidth aggregation states of the virtual cell that the UE supports, and the network may schedule the UE for messages on communication resources that are based on one or more bandwidth aggregation states of the virtual cell that the UE supports.

### FIELD OF TECHNOLOGY

The following relates to wireless communications, including bandwidth aggregation configuration for fractional spectrum integration (FSI).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support bandwidth aggregation configuration for fractional spectrum integration (FSI). For example, the described techniques enable signaling by a network entity of one or more configurations of a virtual cell in accordance with FSI. The virtual cell may be composed of or include one or more subband groups, each subband group including multiple non-contiguous subbands. A partitioning of the virtual cell into subband groups may be based on various parameters, such as a quantity of subband groups that are included in the virtual cell, a range of frequencies over which the subband groups span, a quantity of subbands within a subband group, a frequency gap between adjacent subbands of a subband group, or any combination thereof. Such parameters of the virtual cell may be signaled from the network entity to a user equipment (UE), and the network entity may schedule the UE for communications via the virtual cell based on UE capabilities.

A method for wireless communications by a UE is described. The method may include receiving an indication of a set of configuration parameters of a virtual cell that supports communications for the UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers, transmitting a capability message indicating a capability of the UE to support a subset of the set of configuration parameters of the virtual cell, and receiving a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

A UE is described. The UE may include at least one processor, and at least one memory coupled with the at least one memory, with instructions stored in the at least one memory. The instructions may be executable by the at least one processor, individually or in any combination, to cause the UE to receive an indication of a set of configuration parameters of a virtual cell that supports communications for the UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers, transmit a capability message indicating a capability of the UE to support a subset of the set of configuration parameters of the virtual cell, and receive a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

Another UE for wireless communications is described. The UE may include means for receiving an indication of a set of configuration parameters of a virtual cell that supports communications for the UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers, means for transmitting a capability message indicating a capability of the UE to support a subset of the set of configuration parameters of the virtual cell, and means for receiving a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

A non-transitory computer-readable medium storing code for wireless communications is described. The code may include instructions executable by one or more processors to receive an indication of a set of configuration parameters of a virtual cell that supports communications for the UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers, transmit a capability message indicating a capability of the UE to support a subset of the set of configuration parameters of the virtual cell, and receive a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

In some examples of the method, UEs, and non-transitory computer-readable medium described herein, receiving the indication of the set of configuration parameters of the virtual cell may include operations, features, means, or instructions for receiving an indication of a set of bandwidth aggregation states associated with the virtual cell, where a bandwidth aggregation state of the set of bandwidth aggregation states corresponds to a respective quantity of subband groups configured for the virtual cell, a respective frequency bandwidth configured for the communications with the UE via the virtual cell, a respective threshold quantity of subbands included in each subband group of the quantity of subband groups, a respective threshold frequency gap between adjacent subbands of a subband group, or any combination thereof.

In some examples of the method, UEs, and non-transitory computer-readable medium described herein, transmitting the capability message may include operations, features, means, or instructions for transmitting an indication of a subset of the set of bandwidth aggregation states associated with the virtual cell that the UE supports.

In some examples of the method, UEs, and non-transitory computer-readable medium described herein, the set of resources corresponding to the scheduled one or more messages may be based on a first frequency bandwidth of a first bandwidth aggregation state of the set of bandwidth aggregation states, a first quantity of subband groups associated with the first bandwidth aggregation state, or both and the first bandwidth aggregation state may be based on the subset of the set of configuration parameters of the virtual cell that the UE supports.

In some examples of the method, UEs, and non-transitory computer-readable medium described herein, receiving the indication of the set of configuration parameters of the virtual cell may include operations, features, means, or instructions for receiving an indication of a first subband group including a first subband of a first band of a first radio frequency spectrum band and a second subband of the first band.

In some examples of the method, UEs, and non-transitory computer-readable medium described herein, the first subband includes a second set of resources corresponding to a set of multiple component carriers of the first band and the second set of resources may be contiguous over the set of multiple component carriers.

In some examples of the method, UEs, and non-transitory computer-readable medium described herein, receiving the indication of the set of configuration parameters of the virtual cell may include operations, features, means, or instructions for receiving an indication of a first subband group including a first subband of a first band of a first radio frequency spectrum band and a second subband of a second band of the first radio frequency spectrum band.

In some examples of the method, UEs, and non-transitory computer-readable medium described herein, the first subband group includes a third subband corresponding to a frequency gap between the first band and the second band.

In some examples of the method, UEs, and non-transitory computer-readable medium described herein, receiving the indication of the set of configuration parameters of the virtual cell may include operations, features, means, or instructions for receiving an indication of a first subband group including one or more first subbands of a first band of a first radio frequency spectrum band and a second subband group including one or more subbands of a second band of the first radio frequency spectrum band.

Some examples of the method, UEs, and non-transitory computer-readable medium described herein may further include operations, features, means, or instructions for receiving a reference signal via a first subband of a first subband group, where the reference signal indicates timing information associated with both the first subband and a second subband of the first subband group.

Some examples of the method, UEs, and non-transitory computer-readable medium described herein may further include operations, features, means, or instructions for receiving, at a first transmit power and in accordance with a first spatial filter, a first reference signal via a first subband of a first subband group and receiving, at a second transmit power and in accordance with the first spatial filter, a second reference signal via a second subband of the first subband group, where a difference between the second transmit power and the first transmit power satisfies a threshold.

In some examples of the method, UEs, and non-transitory computer-readable medium described herein, receiving the indication may include operations, features, means, or instructions for receiving the indication via a system information message or a radio resource control (RRC) message.

In some examples of the method, UEs, and non-transitory computer-readable medium described herein, the one or more sub-component carriers include a fraction of a component carrier.

A method for wireless communications by a network entity is described. The method may include outputting an indication of a set of configuration parameters of a virtual cell that supports communications for a UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers, obtaining a capability message indicating a capability of the UE to support a subset of the set of configuration parameters of the virtual cell, and outputting a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

A network entity is described. The network entity may include at least one processor, and at least one memory coupled with the at least one memory, with instructions stored in the at least one memory. The instructions may be executable by the at least one processor, individually or in any combination, to cause the network entity to output an indication of a set of configuration parameters of a virtual cell that supports communications for a UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers, obtain a capability message indicating a capability of the UE to support a subset of the set of configuration parameters of the virtual cell, and output a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

Another network entity for wireless communications is described. The network entity may include means for outputting an indication of a set of configuration parameters of a virtual cell that supports communications for a UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers, means for obtaining a capability message indicating a capability of the UE to support a subset of the set of configuration parameters of the virtual cell, and means for outputting a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

A non-transitory computer-readable medium storing code for wireless communications is described. The code may include instructions executable by one or more processors to output an indication of a set of configuration parameters of a virtual cell that supports communications for a UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers, obtain a capability message indicating a capability of the UE to support a subset of the set of configuration parameters of the virtual cell, and output a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

In some examples of the method, network entities, and non-transitory computer-readable medium described herein, outputting the indication of the set of configuration parameters of the virtual cell may include operations, features, means, or instructions for outputting an indication of a set of bandwidth aggregation states associated with the virtual cell, where a bandwidth aggregation state of the set of bandwidth aggregation states corresponds to a respective quantity of subband groups configured for the virtual cell, a respective frequency bandwidth configured for the communications with the UE via the virtual cell, a respective threshold quantity of subbands included in each subband group of the quantity of subband groups, a respective threshold frequency gap between adjacent subbands of a subband group, or any combination thereof.

In some examples of the method, network entities, and non-transitory computer-readable medium described herein, obtaining the capability message may include operations, features, means, or instructions for obtaining an indication of a subset of the set of bandwidth aggregation states associated with the virtual cell that the UE supports.

In some examples of the method, network entities, and non-transitory computer-readable medium described herein, the set of resources corresponding to the scheduled one or more messages may be based on a first frequency bandwidth of a first bandwidth aggregation state of the set of bandwidth aggregation states, a first quantity of subband groups associated with the first bandwidth aggregation state, or both and the first bandwidth aggregation state may be based on the subset of the set of configuration parameters of the virtual cell that the UE supports.

In some examples of the method, network entities, and non-transitory computer-readable medium described herein, outputting the indication of the set of configuration parameters of the virtual cell may include operations, features, means, or instructions for outputting an indication of a first subband group including a first subband of a first band of a first radio frequency spectrum band and a second subband of the first band.

In some examples of the method, network entities, and non-transitory computer-readable medium described herein, the first subband includes a second set of resources corresponding to a set of multiple component carriers of the first band and the second set of resources may be contiguous over the set of multiple component carriers.

In some examples of the method, network entities, and non-transitory computer-readable medium described herein, outputting the indication of the set of configuration parameters of the virtual cell may include operations, features, means, or instructions for outputting an indication of a first subband group including a first subband of a first band of a first radio frequency spectrum band and a second subband of a second band of the first radio frequency spectrum band.

In some examples of the method, network entities, and non-transitory computer-readable medium described herein, the first subband group includes a third subband corresponding to a frequency gap between the first band and the second band.

In some examples of the method, network entities, and non-transitory computer-readable medium described herein, outputting the indication of the set of configuration parameters of the virtual cell may include operations, features, means, or instructions for outputting an indication of a first subband group including one or more first subbands of a first band of a first radio frequency spectrum band and a second subband group including one or more subbands of a second band of the first radio frequency spectrum band.

Some examples of the method, network entities, and non-transitory computer-readable medium described herein may further include operations, features, means, or instructions for outputting a reference signal via a first subband of a first subband group, where the reference signal indicates timing information associated with both the first subband and a second subband of the first subband group.

Some examples of the method, network entities, and non-transitory computer-readable medium described herein may further include operations, features, means, or instructions for outputting, at a first transmit power and in accordance with a first spatial filter, a first reference signal via a first subband of a first subband group and outputting, at a second transmit power and in accordance with the first spatial filter, a second reference signal via a second subband of the first subband group, where a difference between the second transmit power and the first transmit power satisfies a threshold.

In some examples of the method, network entities, and non-transitory computer-readable medium described herein, outputting the indication may include operations, features, means, or instructions for outputting the indication via a system information message or an RRC message.

In some examples of the method, network entities, and non-transitory computer-readable medium described herein, the one or mor sub-component carriers include a fraction of a component carrier.

### BRIEF DESCRIPTION OF THE DRAWINGS

FIG. 1 shows an example of a wireless communications system that supports bandwidth aggregation configuration for fractional spectrum integration (FSI) in accordance with one or more aspects of the present disclosure.

FIG. 2 shows an example of a wireless communications system that supports bandwidth aggregation configuration for FSI in accordance with one or more aspects of the present disclosure.

FIGS. 3A-3C shows examples of resource diagrams that support bandwidth aggregation configuration for FSI in accordance with one or more aspects of the present disclosure.

FIG. 4 shows an example of a process flow that supports bandwidth aggregation configuration for FSI in accordance with one or more aspects of the present disclosure.

FIGS. 5 and 6 show block diagrams of devices that support bandwidth aggregation configuration for FSI in accordance with one or more aspects of the present disclosure.

FIG. 7 shows a block diagram of a communications manager that supports bandwidth aggregation configuration for FSI in accordance with one or more aspects of the present disclosure.

FIG. 8 shows a diagram of a system including a device that supports bandwidth aggregation configuration for FSI in accordance with one or more aspects of the present disclosure.

FIGS. 9 and 10 show block diagrams of devices that support bandwidth aggregation configuration for FSI in accordance with one or more aspects of the present disclosure.

FIG. 11 shows a block diagram of a communications manager that supports bandwidth aggregation configuration for FSI in accordance with one or more aspects of the present disclosure.

FIG. 12 shows a diagram of a system including a device that supports bandwidth aggregation configuration for FSI in accordance with one or more aspects of the present disclosure.

FIGS. 13 and 14 show flowcharts illustrating methods that support bandwidth aggregation configuration for FSI in accordance with one or more aspects of the present disclosure.

### DETAILED DESCRIPTION

In some wireless communications systems (e.g., 5th generation (5G) systems, 6th generation (6G) systems, or beyond), a network entity may communicate with a user equipment (UE) via a virtual cell over non-contiguous subbands. The virtual cell may be formed by fractional spectrum integration (FSI). For example, the virtual cell may include multiple subbands which may be separated relative to one another by one or more frequency gaps. In some examples, the multiple subbands of the virtual cell may be associated with respective cells of a network entity, or the multiple subbands may be associated with a same cell of the network entity. For example, the virtual cell may be referred to as a logical cell, and configurations of the logical cell may be broadcast by the network entity via a single cell to one or more UEs that may be in communication with the cell (e.g., via an established connection, such as being camped at the cell or otherwise serviced by the cell). In some cases, the UE may be configured to transmit or receive messages via the virtual cell, and different portions of the message may be communicated over the non-contiguous subbands simultaneously. In some examples, the non-contiguous subbands of the virtual cell may each correspond to a respective radio frequency spectrum band (e.g., frequency band 3 (FR3), frequency range 4 (FR4), frequency range 5 (FR5), etc.). Each subband may include multiple aggregated component carriers. Different from carrier aggregation configurations, however, the component carriers of a subband of the virtual cell may be continuous (e.g., without gaps, ignoring guard band restrictions), and may support channel bandwidths which may otherwise by unsupported by carrier aggregation (such as resources of a frequency gap between two component carriers belonging to different frequency bands). In some examples, additional signaling may be implemented by the network entity to configure the UE for communication over non-contiguous subbands of the virtual cell.

In accordance with examples described herein, a network entity may configure a virtual cell for communication between the UE and the network entity in accordance with a set of bandwidth aggregation states of the virtual cell. A bandwidth aggregation state may indicate a quantity of subband groups configured for the virtual cell, a frequency range of aggregated bandwidth supported by the virtual cell (e.g., while the virtual cell is configured in the bandwidth aggregation state), a quantity of subbands within each subband group, and a frequency separation between adjacent subbands in the subband group. In some examples, a UE may transmit capability signaling to indicate to the network entity a subset of the set of bandwidth aggregation states of the virtual cell that the UE supports, and the network may schedule the UE for messages (e.g., downlink messages, uplink messages) on communication resources that are based on one or more bandwidth aggregation states of the virtual cell that the UE supports.

Aspects of the disclosure are initially described in the context of wireless communications systems. Aspects of the disclosure are further described in the context of wireless communications systems, resource diagrams, and process flows. Aspects of the disclosure are further illustrated by and described herein with reference to apparatus diagrams, system diagrams, and flowcharts that relate to bandwidth aggregation configuration for FSI.

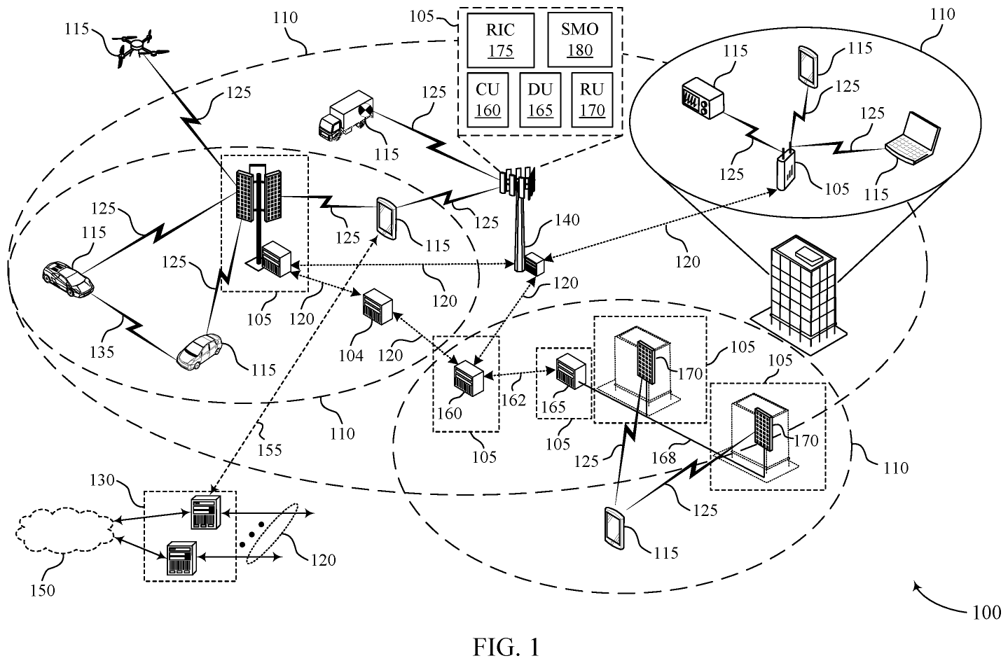

FIG. 1 shows an example of a wireless communications system 100 that supports bandwidth aggregation configuration for FSI in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a subband, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 MHz to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In accordance with examples described herein, a network entity 105 may configure or support a virtual cell for communication between the UE 115 and the network entity 105 in accordance with a set of bandwidth aggregation states of the virtual cell. A bandwidth aggregation state may indicate a quantity of subband groups configured for the virtual cell, a frequency range of aggregated bandwidth supported by the virtual cell (e.g., while the virtual cell is configured in the bandwidth aggregation state), a quantity of subbands within each subband group, and a frequency separation between adjacent subbands in the subband group. In some examples, a UE 115 may transmit capability signaling to indicate to the network entity 105 a subset of the set of bandwidth aggregation states of the virtual cell that the UE 115 supports, and the network entity 105 may schedule the UE 115 for messages (e.g., downlink messages, uplink messages) on communication resources that are based on one or more bandwidth aggregation states of the virtual cell that the UE 115 supports.

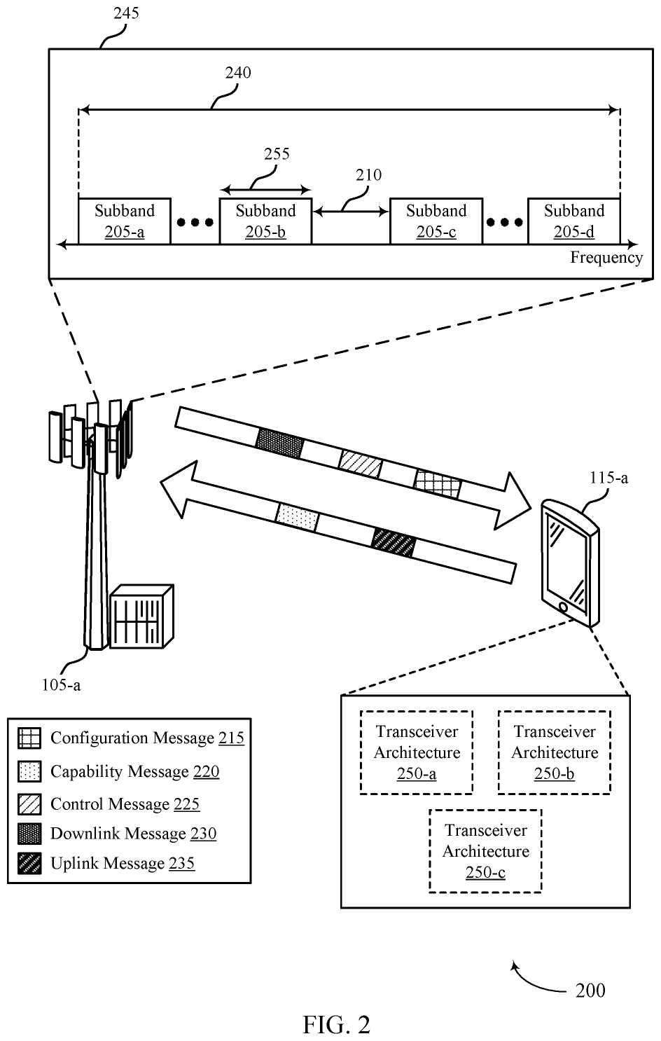

FIG. 2 shows an example of a wireless communications system 200 that supports bandwidth aggregation configuration for FSI in accordance with one or more aspects of the present disclosure. The wireless communications system 200 may implement or may be implemented by aspects of the wireless communications system 100. For example, the wireless communications system 200 may include a UE 115-a and a network entity 105-a, which may be examples of corresponding devices described herein.

A cell of the network entity 105-a may be a virtual cell 245. The virtual cell 245 may be formed by FSI. For example, the virtual cell 245 may include multiple subbands 205 (e.g., a subband 205-a, a subband 205-b, a subband 205-c, a subband 205-d). The subbands 205 may be separated respective to one another by a frequency gap 210 (e.g., a frequency gap 210 between the subband 205-b and the subband 205-c). An aggregated bandwidth 240 of the virtual cell 245 may be a set of frequencies that spans the subbands 205 (e.g., from the subband 205-a to the subband 205-d). In some examples, thresholds on the frequency gap 210, a round trip delay, or an average reception power difference associated with the virtual cell 245 may be configured to comply with existing configurations (e.g., for homogenous, non-virtual cells) of numerology, waveform, timing advance, source reference signal for L1 or L2 measurements, quasi-colocation relationships, or any combination thereof. In some examples, the multiple subbands 205 associated with the virtual cell 245 may each correspond to respective radio frequency spectrum bands. The radio frequency spectrum bands may include frequency range 1 (FR1), frequency range 2 (FR2), FR3, FR4, FR5, frequency range 6 (FR6), among other frequency ranges. In an example, the subband 205-a may correspond to FR2, the subband 205-b may correspond to FR3, the subband 205-c may correspond to FR4, and the subband 205-d may correspond to FR5.

In some examples, the UE 115-a may be configured to communicate with the network entity 105-a via a virtual cell 245 that includes non-contiguous subbands 205 for communication of a downlink message 230, an uplink message 235, or both. For example, the UE 115 a may receive a control message 225 (e.g., DCI) indicating scheduling information for the downlink message 230 or the uplink message 235 that is scheduled for transmission via a first subband 205-b of a first radio frequency spectrum band and via a second subband 205-c of a second radio frequency spectrum band. The first subband 205-b and the second subband 205-c may be non-contiguous bands (e.g., separated by the frequency gap 210) associated with the virtual cell 245.

A configuration of the virtual cell 245 at the network entity 105-a may differ from carrier aggregation configurations in various ways. For example, for carrier aggregation, a channel bandwidth of each component carrier may satisfy minimum and maximum channel bandwidth thresholds, which may be band-specific and/or subcarrier spacing-specific. In an example, for a first frequency band (e.g., n1) and a subcarrier spacing of 15 kilohertz (kHz), a minimum channel bandwidth threshold may be 5 MHz and a maximum channel bandwidth threshold may be 50 MHz. For the virtual cell 245, however, a subband 205-b may occupy, or may correspond to, a set of frequency resources 255 that is less than a minimum channel bandwidth threshold for carrier aggregation. For example, the subband 205-b may span 1.4 MHz of frequency resources, which may be less than the minimum channel bandwidth for carrier aggregation. That is, the subband 205-b may include one or more sub-component carriers, and the one or more sub-component carriers may include a fraction of a component carrier. Alternatively, the set of frequency resources 255 may be greater than a maximum channel bandwidth threshold for carrier aggregation. In such cases, the subband 205-b may include the set of frequency resources 255 that includes multiple component carriers.

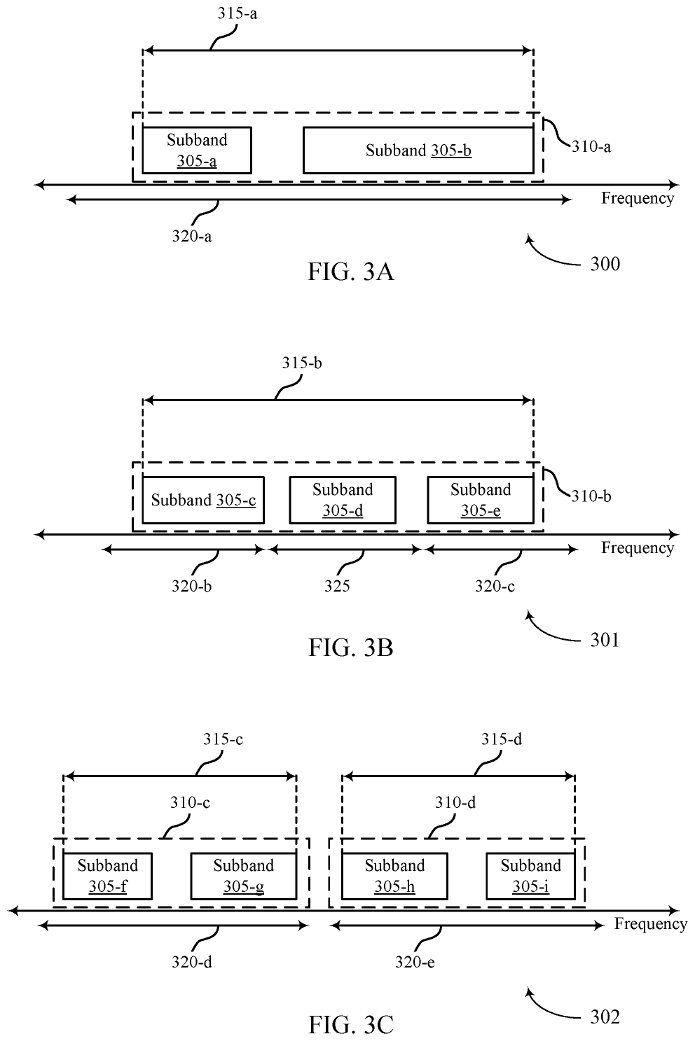

In some examples, for carrier aggregation configurations, guard bands (e.g., frequency gaps) may be reserved between component carriers of the carrier aggregation, and such guard bands may not be configured for scheduling communications (e.g., messages, reference signals) between the network entity 105-a and the UE 115-a. That is, component carriers of a carrier aggregation may be non-contiguous, and guard bands consisting of reserved frequency resources may be positioned between aggregated component carriers. For the virtual cell 245, however, the subband 205-b may include the set of frequency resources 255 which may include multiple component carriers, and the set of frequency resources 255 may be contiguous over the multiple component carriers (e.g., without guard bands or frequency gaps). That is, multiple component carriers may be aggregated on a virtual cell 245 and mapped to a single subband 205-b without inter-component carrier guard bands (e.g., which may differ from intra-band, contiguous carrier aggregation configurations). Additionally, or alternatively, the virtual cell 245 may include a quantity of non-contiguous subbands 205 that exceeds a threshold quantity of non-contiguous component carriers for a carrier aggregation configuration (e.g., an intra-band, non-contiguous carrier aggregation). In some examples, the network entity 105-a may schedule resources (e.g., via a frequency domain resource allocation (FDRA)) for data or reference signals on a virtual cell 245, and the scheduled resources may include a frequency gap between two component carriers belonging to different frequency bands (e.g., as described herein in greater detail with reference to FIG. 3).

In some examples, to unify bandwidth aggregation indication and enhance UE capability reporting for FSI, the network entity 105-a may classify (e.g., indicate, define) valid bandwidth aggregation states of a virtual cell and may indicate a set of bandwidth aggregation states to the UE 115-a via the configuration message 215. For example, the UE 115-a may receive an indication of a set of configuration parameters of the virtual cell for supporting communication with the UE 115-a, and the set of configuration parameters may include, or may be based on, the set of bandwidth aggregation states. The bandwidth aggregation states may be based on subband groups of the virtual cell which may each include one or more subbands 205. In some cases, a bandwidth aggregation state (e.g., a bandwidth aggregation class) may indicate a configuration of subband groups within the virtual cell 245 via a set of one or more configuration parameters. The set of configuration parameters may include a quantity of subband groups configured for the virtual cell, a range of aggregated bandwidth for subband groups, a threshold (e.g., maximum, minimum) frequency separation between adjacent subbands 205 in a subband group, a threshold quantity of subbands 205 of a subband group, or any combination thereof. For example, in accordance with Table 1, the network entity may indicate a set of subband group aggregation classes (e.g., A, B, C, D) and for each aggregation class may indicate a range of aggregated bandwidth (e.g., a frequency bandwidth configured for communications with the UE 115-a via the virtual cell 245), a maximum quantity of subbands 205 in a subband group, a maximum frequency gap between adjacent subbands 205 of a subband group, and a minimum threshold frequency gap between adjacent subbands 205 of a subband group.

TABLE 1

| | | | Maximum | Minimum |
|---|---|---|---|---|
| | | Maximum | Frequency | Frequency |
| Subband | | Quantity of | Separation | Separation |
| Group | Range of | Subbands in a | Between | Between |
| Aggregation | Aggregated | Subband | Adjacent | Adjacent |
| Class | Bandwidth | Group | Subbands | Subbands |
| A | (α_{A}, β_{A}] | M_{A} | Δ_{A} | Δ_{E} |
| B | (α_{B}, β_{B}] | M_{B} | Δ_{B} | Δ_{F} |
| C | (α_{C}, β_{C}] | M_{c} | Δ_{C} | Δ_{G} |
| D | (α_{D}, β_{D}] | M_{D} | Δ_{D} | Δ_{H} |

In some examples, the range of aggregated bandwidth may correspond to relatively higher frequencies from one bandwidth aggregation state to another, or the range of aggregated bandwidth may be greater (e.g., may correspond to a broader range of frequencies) from one bandwidth aggregation state to another, or both. For example, a bandwidth aggregation state supporting a broader range of aggregated bandwidth may be referred to as a relatively higher order bandwidth aggregation state and a bandwidth aggregation state supporting a narrow range of aggregated bandwidth may be referred to as a relatively lower order bandwidth aggregation state. In some cases, the aggregated bandwidth of one bandwidth aggregation state may overlap relative to one or more other aggregated bandwidths of other bandwidth aggregation states. In some examples, the maximum frequency separation between adjacent subbands 205, the minimum frequency separation between adjacent subbands 205, or both may be a function of (e.g., may be based on) the range of aggregated bandwidth or the maximum quantity of subbands 205 in a subband group, among other parameters. In some examples, the minimum frequency separation between adjacent subbands 205 may be based on a lack of availability of communication resources within the aggregated bandwidth 240, or may support reduced interference between subbands 205 of the virtual cell 245.

In some examples, the UE 115-a may transmit a capability message 220 to the network entity 105-a that indicates a capability of the UE 115-a to support a subset of the bandwidth aggregation states of the virtual cell 245. For example, the UE 115-a may indicate a capability for FSI and/or virtual cells 245. Additionally, or alternatively, the UE 115-a may indicate capabilities or transceiver architectures 250 associated with, or corresponding to, difference bandwidth aggregation states. For example, the UE 115-a may indicate that the UE 115-a supports at least one of a transceiver architecture 250-a, which may correspond to a first bandwidth aggregation state (e.g., a bandwidth aggregation state A), a transceiver architecture 250-b, which may correspond to a second bandwidth aggregation state (e.g., a bandwidth aggregation state B), and a transceiver architecture 250-c, which may correspond to one or more third bandwidth aggregation states different from (e.g., a higher order than) the first and second bandwidth aggregation states (e.g., a bandwidth aggregation state C, a bandwidth aggregation state D).

According to the capability message 220, the network entity 105-a may schedule one or more downlink messages 230 (e.g., control message, data message, reference signal), one or more uplink messages 235 (e.g., control message, data message, reference signal), or both for the UE 115-a on one or multiple subband groups within an active bandwidth part of the UE 115-a. The one or multiple subband groups that are scheduled for communications, the active bandwidth part of the UE 115-a, or both, may be in accordance with a bandwidth aggregation state that is configured for the virtual cell (e.g., currently active bandwidth aggregation state at the UE 115-a), a set of configuration parameters of the virtual cell indicated by the network entity 105-a, or both. In some cases, the network entity 105-a may schedule the UE 115-a to communicate via a single subband group based on the UE 115-a indicating the transceiver architecture 250-a (e.g., or a capability for a bandwidth aggregation state A), or may schedule the UE 115-a to communicate via multiple subband groups based on the UE 115-a indicating the transceiver architecture 250-b (e.g., or a capability for a bandwidth aggregation state B), or both. That is, a bandwidth aggregation state (e.g., a set of configuration parameters) that the network entity 105-a configures for the virtual cell 245 at the UE 115-a may be based on the capability message 220, the transceiver architectures 250, a capability of the UE for one or more bandwidth aggregation states, or any combination thereof.

In some examples, the network entity 105-a may schedule transmission and/or measurement of reference signals outside the active bandwidth part of the UE 115-a. For example, the virtual cell 245 may be configured in a first bandwidth aggregation state for communication with the UE 115-a, and the network entity 105-a may schedule communication of one or more downlink messages 230 or uplink messages 235 on resources of subband groups outside of (e.g., not part of) the first bandwidth aggregation state. In such examples, the network entity 105-a may schedule the communication with a gap (e.g., a radio frequency retuning gap) based on the UE 115-a indicating support of the transceiver architecture 250-a. Alternatively, the network entity 105-a may schedule the communications at the UE 115-a without a gap (e.g., in cases where the UE 115-a indicates support of the transceiver architecture 250-b or the transceiver architecture 250-c, which may support relatively higher order bandwidth aggregation states, a higher range of aggregated bandwidth of the virtual cell 245, or both).

FIGS. 3A-3C show examples of a resource diagram 300, a resource diagram 301, and a resource diagram 302 that support bandwidth aggregation configuration for FSI in accordance with one or more aspects of the present disclosure. The resource diagram 300, the resource diagram 301, and the resource diagram 302 may implement or may be implemented by aspects of the wireless communications system 100 or the wireless communications system 200. For example, the resource diagram 300, the resource diagram 301, and the resource diagram 302 may include configurations of a virtual cell 245 of a network entity 105-a, as described herein with reference to FIG. 2.

In some examples, multiple subbands 305 may correspond to (e.g., may be mapped to, may be associated with, may be positioned within, may be configured for) a virtual cell and may be partitioned into non-overlapping and non-contiguous subband groups 310. Each subband 305 may be mapped to a fraction of a component carrier, or one or more component carriers of a same frequency band 320. In some cases, a subband 305 may be allocated with contiguous frequency resources spanning multiple component carriers (e.g., without inter-component carrier guard bands). Each subband group 310 may correspond to (e.g., may be mapped to, may be associated with, may be positioned within) one or multiple frequency bands 320. A set of subbands 305 of a subband group 310 may be mapped to the same radio frequency spectrum band (e.g., one of FR1, FR2, FR3, etc.). The set of subbands 305 may share a same set of propagation properties (e.g., path loss, multipath delay profile, etc.). Additionally, or alternatively, the set of subbands 305 of a subband group 310 may share a same synchronization reference signal, may be of a same timing advance group (TAG), or both.

The resource diagram 300 shows an example of a configuration of the virtual cell that may include a subband group 310-a. The subband group 310-a may include a subband 305-a and a subband 305-b, which may be of an aggregated bandwidth 315-a of the subband group 310-a. The subband 305-a and the subband 305-b may correspond to (e.g., may be mapped to, may be associated with, may be positioned within) a same frequency band 320-a. In some cases, a network entity may transmit a synchronization reference signal (e.g., a synchronization signal block (SSB)) via the subband 305-a of the subband group 310-a. The synchronization reference signal may be used as a common timing or frequency synchronization reference for the other subbands 305 (e.g., the subband 305-b) of the subband group 310-a. That is, the reference signal received via the subband 305-a may indicate common timing or synchronization information to be applied (e.g., by a UE) to the subband 305-a and the subband 305-b of the subband group 310-a. In some examples, two downlink reference signals (e.g., channel state information (CSI) reference signal, tracking reference signal (TRS), SSB) may be transmitted with a same power or spatial filter on a subband group 310-a. For example, a first downlink reference signal may be transmitted via the subband 305-a and a second downlink reference signal may be transmitted via the subband 305-b. In such examples, a reference signal received power (RSRP) difference between the first downlink reference signal and the second downlink reference signal may satisfy a preconfigured threshold (e.g., a maximum received power difference (MRPD) threshold).

The resource diagram 301 shows an example of a configuration of the virtual cell that may include a subband group 310-b. The subband group 310-b may include a subband 305-c, a subband 305-d, and a subband 305-e, which may be of an aggregated bandwidth 315-b of the subband group 310-b. The subband 305-c may correspond to a frequency band 320-b and the subband 305-e may correspond to a frequency band 320-c. In some examples, a spectrum of the two adjacent frequency bands 320-a and 320-b may be available to the network entity (e.g., mobile network operator (MNO), and a set of frequency resources 325 within a frequency gap between the two adjacent subbands 305 may be configured for the virtual cell. The subband 305-d of the subband group 310-b may correspond to the set of frequency resources 325 (e.g., may be positioned in the frequency gap between the subband 305-c and the subband 305-e).

The resource diagram 302 shows an example of a configuration of the virtual cell that may include a subband group 310-c and a subband group 310-d. The subband group 310-c may include a subband 305-f and a subband 305-g, which may be of an aggregated bandwidth 315-c of the subband group 310-c. The subband 305-f and the subband 305-g may both correspond to a frequency band 320-d. The subband group 310-d may include a subband 305-h and a subband 305-i, which may be of an aggregated bandwidth 315-d of the subband group 310-d. The subband 305-h and the subband 305-i may both correspond to a frequency band 320-e.

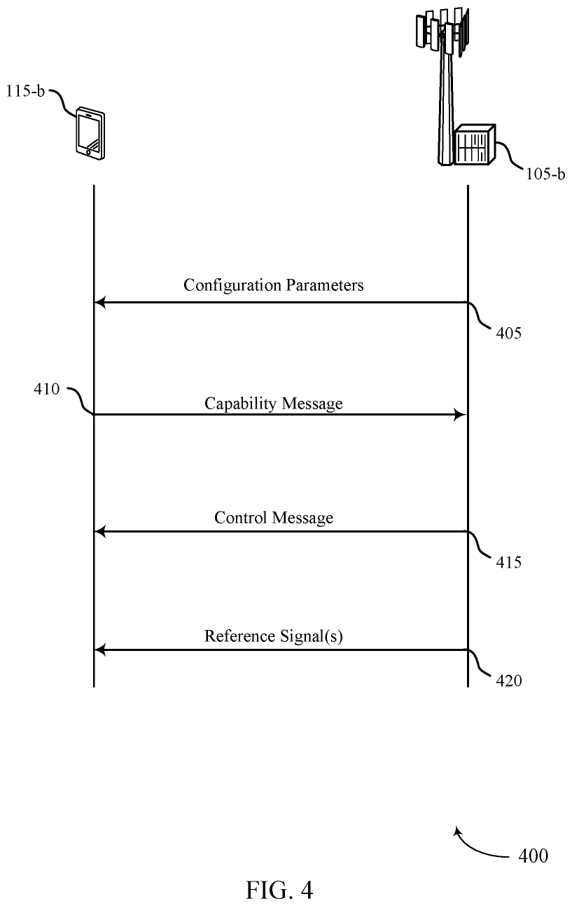

FIG. 4 shows an example of a process flow 400 that supports bandwidth aggregation configuration for FSI in accordance with one or more aspects of the present disclosure. The process flow 400 may implement or may be implemented by aspects of the wireless communications system 100, the wireless communications system 200, or the resource diagram 300. For example, the process flow 400 may include a UE 115-b and a network entity 105-b, which may be examples of corresponding devices described herein.

In the following description of the process flow 400, the operations may be performed in a different order than the order shown, or other operations may be added or removed from the process flow 400. For example, some operations may also be left out of process flow 400, may be performed in different orders or at different times, or other operations may be added to process flow 400. Although communications of the process flow 400 are shown occurring between a UE 115-b and a network entity 105-b, some aspects of some operations may also be performed by one or more other wireless devices, network devices, or network functions.

At 405, the UE 115-b may receive an indication of a set of configuration parameters (e.g., a set of bandwidth aggregation states) of a virtual cell that supports communications for the UE 115-b. The set of configuration parameters may indicate a set of subband groups associated with the virtual cell. Each subband group of the set of subband groups may include multiple non-contiguous subbands of a same radio frequency spectrum band (e.g., FR1, FR2, FR3, etc.). Each subband of the set of non-contiguous subbands may include one or more sub-component carriers. For example, each subband may include a fraction of a component carrier, a single component carrier, or a set of contiguous frequency resources spanning multiple component carriers (e.g., without inter-component carrier guard bands), or any combination thereof. The UE 115-b may receive the indication via a system information message or an RRC message.

In some examples, the indication of the set of configuration parameters may include a set of bandwidth aggregation states of the virtual cell. A bandwidth aggregation state may be indicative of a quantity of subband groups configured for communications via the virtual cell, a frequency bandwidth configured for communications via the virtual cell, a threshold quantity of subbands included in each subband group of the quantity of subband groups, or a threshold (e.g., minimum, maximum) frequency gap between adjacent subbands of a subband group, or any combination thereof.

At 410, the UE 115-b may transmit a capability message indicating a capability of the UE 115-b to support a subset of the set of configuration parameters of the virtual cell. For example, the UE 115-b may indicate a capability to support a subset of the set of bandwidth aggregation states of the virtual cell. Additionally, or alternatively, the UE 115-b may indicate that the UE 115-b supports one or more transceiver architectures. The one or more transceiver architectures may correspond to a respective bandwidth aggregation state indicated by the network entity 105-b.

At 415, the UE 115-b may receive a control message (e.g., DCI) that indicates scheduling information associated with one or more messages for communication via the virtual cell. The one or more messages may be scheduled on a set of resources corresponding to one or more subband groups of the set of subband groups. The one or more subband groups scheduled for communication may be based on a bandwidth aggregation state of the virtual cell. For example, the set of scheduled resources may be based on a first bandwidth aggregation state of the set of bandwidth aggregation states, a first quantity of subband groups indicated by the first bandwidth aggregation state, or both. The first bandwidth aggregation state or the first quantity of subband groups may be based on the subset of the set of configuration parameters that the UE supports.

At 420, the UE 115-b may receive one or more reference signals from the network entity 105-b via a subband of the virtual cell. For example, the UE 115-b may receive a reference signal (e.g., synchronization reference signal, SSB) via a first subband of a first subband group. The reference signal may indicate timing information that applies to both the first subband and one or more other subbands of the first subband group. In some other examples, the UE 115-b may receive a first reference signal via a first subband of a first subband group. The first reference signal may be transmitted by the network entity 105-b at a first transmit power and using a first power or spatial filter. The UE 115-b may also receive a second reference signal via a second subband of the first subband group. The second reference signal may be transmitted by the network entity 105-b at a second transmit power and using the first power or spatial filter. In some examples (e.g., based on the first reference signal and the second reference signal being transmitted on a same subband group), an RSRP difference between the second transmit power and the first transmit power may satisfy a threshold (e.g., a MRPD threshold).

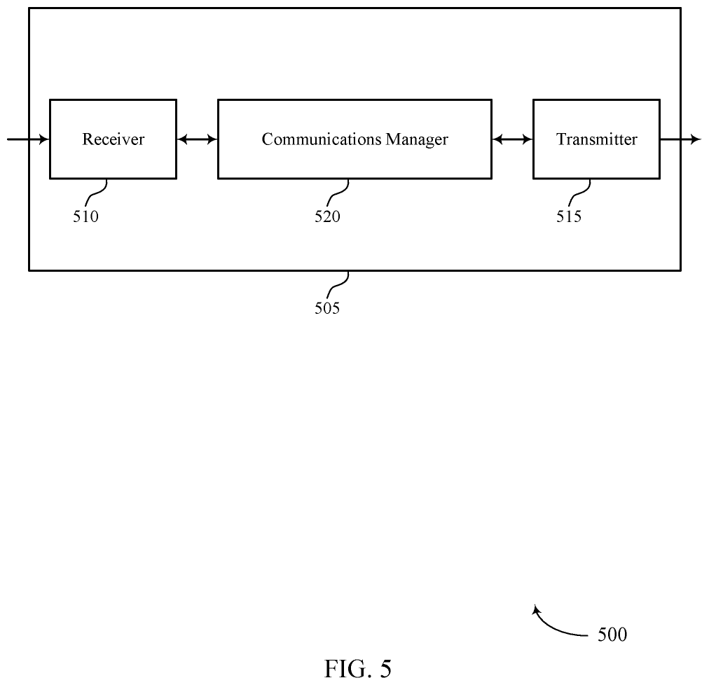

FIG. 5 shows a block diagram 500 of a device 505 that supports bandwidth aggregation configuration for FSI in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to bandwidth aggregation configuration for FSI). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to bandwidth aggregation configuration for FSI). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of bandwidth aggregation configuration for FSI as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving an indication of a set of configuration parameters of a virtual cell that supports communications for the UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers. The communications manager 520 is capable of, configured to, or operable to support a means for transmitting a capability message indicating a capability of the UE to support a subset of the set of configuration parameters of the virtual cell. The communications manager 520 is capable of, configured to, or operable to support a means for receiving a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

By including or configuring the communications manager 520 in accordance with examples as described herein, the device 505 (e.g., at least one processor controlling or otherwise coupled with the receiver 510, the transmitter 515, the communications manager 520, or any combination thereof) may support techniques for reduced signaling overhead, reduced processing, and increased spectrum utilization efficiency.

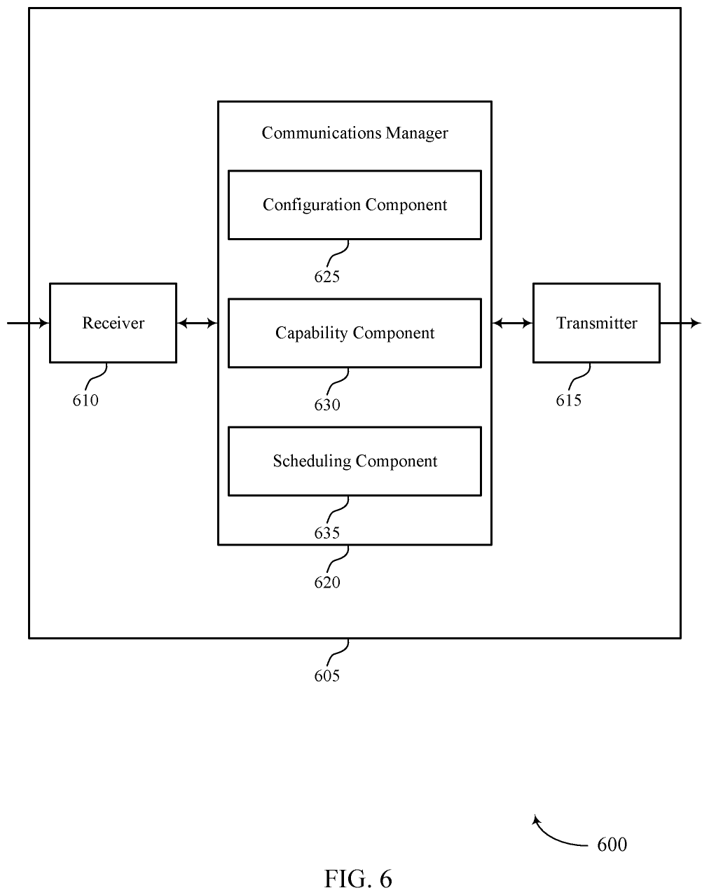

FIG. 6 shows a block diagram 600 of a device 605 that supports bandwidth aggregation configuration for FSI in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to bandwidth aggregation configuration for FSI). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to bandwidth aggregation configuration for FSI). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of bandwidth aggregation configuration for FSI as described herein. For example, the communications manager 620 may include a configuration component 625, a capability component 630, a scheduling component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The configuration component 625 is capable of, configured to, or operable to support a means for receiving an indication of a set of configuration parameters of a virtual cell that supports communications for the UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers. The capability component 630 is capable of, configured to, or operable to support a means for transmitting a capability message indicating a capability of the UE to support a subset of the set of configuration parameters of the virtual cell. The scheduling component 635 is capable of, configured to, or operable to support a means for receiving a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

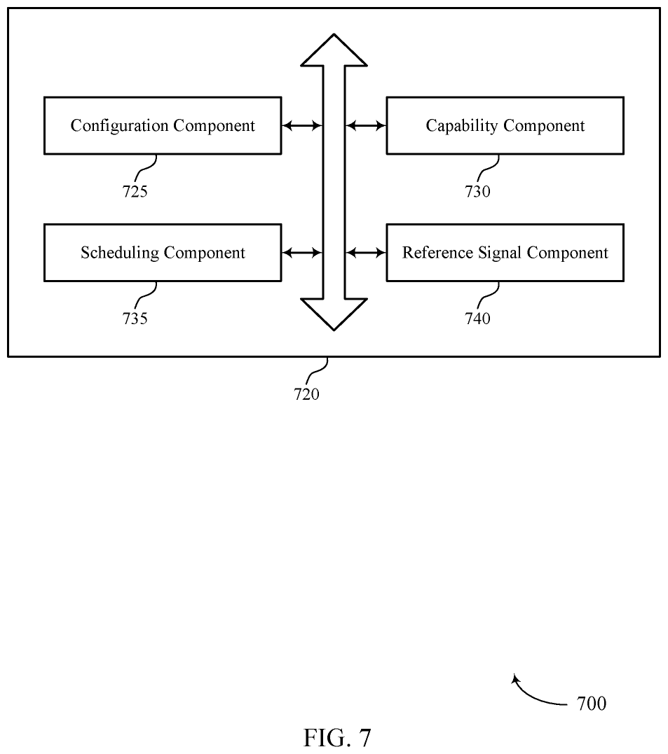

FIG. 7 shows a block diagram 700 of a communications manager 720 that supports bandwidth aggregation configuration for FSI in accordance with one or more aspects of the present disclosure. The communications manager 720 may be an example of aspects of a communications manager 520, a communications manager 620, or both, as described herein. The communications manager 720, or various components thereof, may be an example of means for performing various aspects of bandwidth aggregation configuration for FSI as described herein. For example, the communications manager 720 may include a configuration component 725, a capability component 730, a scheduling component 735, a reference signal component 740, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The configuration component 725 is capable of, configured to, or operable to support a means for receiving an indication of a set of configuration parameters of a virtual cell that supports communications for the UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers. The capability component 730 is capable of, configured to, or operable to support a means for transmitting a capability message indicating a capability of the UE to support a subset of the set of configuration parameters of the virtual cell. The scheduling component 735 is capable of, configured to, or operable to support a means for receiving a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

In some examples, to support receiving the indication of the set of configuration parameters of the virtual cell, the configuration component 725 is capable of, configured to, or operable to support a means for receiving an indication of a set of bandwidth aggregation states associated with the virtual cell, where a bandwidth aggregation state of the set of bandwidth aggregation states corresponds to a respective quantity of subband groups configured for the virtual cell, a respective frequency bandwidth configured for the communications with the UE via the virtual cell, a respective threshold quantity of subbands included in each subband group of the quantity of subband groups, a respective threshold frequency gap between adjacent subbands of a subband group, or any combination thereof.

In some examples, to support transmitting the capability message, the capability component 730 is capable of, configured to, or operable to support a means for transmitting an indication of a subset of the set of bandwidth aggregation states associated with the virtual cell that the UE supports.

In some examples, the set of resources corresponding to the scheduled one or more messages is based on a first frequency bandwidth of a first bandwidth aggregation state of the set of bandwidth aggregation states, a first quantity of subband groups associated with the first bandwidth aggregation state, or both. In some examples, the first bandwidth aggregation state is based on the subset of the set of configuration parameters of the virtual cell that the UE supports.

In some examples, to support receiving the indication of the set of configuration parameters of the virtual cell, the configuration component 725 is capable of, configured to, or operable to support a means for receiving an indication of a first subband group including a first subband of a first band of a first radio frequency spectrum band and a second subband of the first band.

In some examples, the first subband includes a second set of resources corresponding to a set of multiple component carriers of the first band. In some examples, the second set of resources is contiguous over the set of multiple component carriers.

In some examples, to support receiving the indication of the set of configuration parameters of the virtual cell, the configuration component 725 is capable of, configured to, or operable to support a means for receiving an indication of a first subband group including a first subband of a first band of a first radio frequency spectrum band and a second subband of a second band of the first radio frequency spectrum band.

In some examples, the first subband group includes a third subband corresponding to a frequency gap between the first band and the second band.

In some examples, to support receiving the indication of the set of configuration parameters of the virtual cell, the configuration component 725 is capable of, configured to, or operable to support a means for receiving an indication of a first subband group including one or more first subbands of a first band of a first radio frequency spectrum band and a second subband group including one or more subbands of a second band of the first radio frequency spectrum band.

In some examples, the reference signal component 740 is capable of, configured to, or operable to support a means for receiving a reference signal via a first subband of a first subband group, where the reference signal indicates timing information associated with both the first subband and a second subband of the first subband group.

In some examples, the reference signal component 740 is capable of, configured to, or operable to support a means for receiving, at a first transmit power and in accordance with a first spatial filter, a first reference signal via a first subband of a first subband group. In some examples, the reference signal component 740 is capable of, configured to, or operable to support a means for receiving, at a second transmit power and in accordance with the first spatial filter, a second reference signal via a second subband of the first subband group, where a difference between the second transmit power and the first transmit power satisfies a threshold.

In some examples, to support receiving the indication, the configuration component 725 is capable of, configured to, or operable to support a means for receiving the indication via a system information message or an RRC message.

In some examples, the one or more sub-component carriers include a fraction of a component carrier.

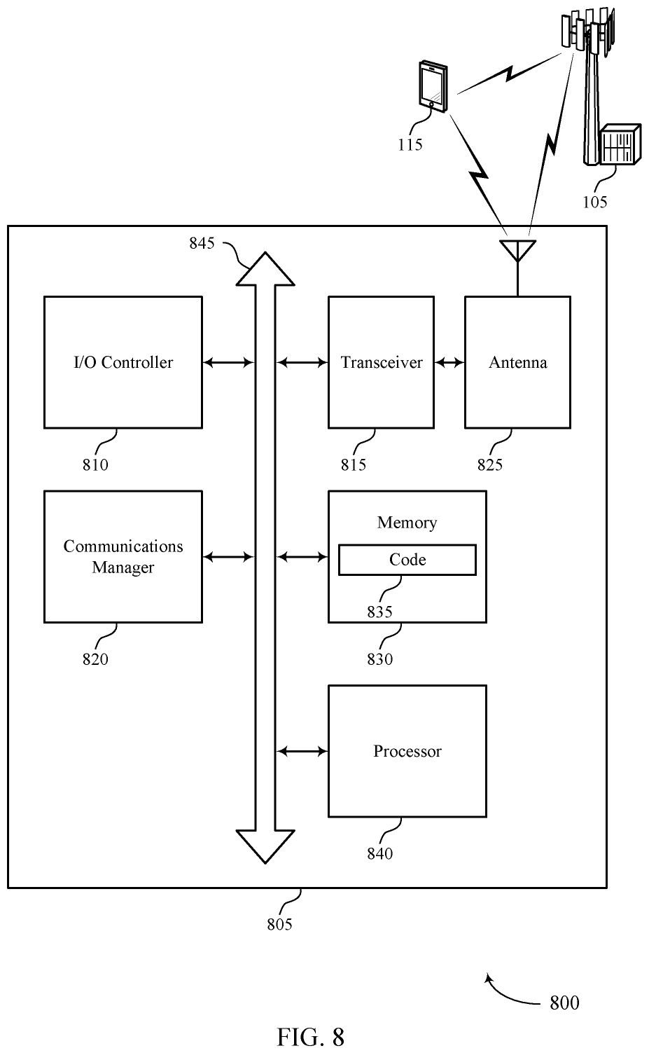

FIG. 8 shows a diagram of a system 800 including a device 805 that supports bandwidth aggregation configuration for FSI in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or any combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting bandwidth aggregation configuration for FSI). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving an indication of a set of configuration parameters of a virtual cell that supports communications for the UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers. The communications manager 820 is capable of, configured to, or operable to support a means for transmitting a capability message indicating a capability of the UE to support a subset of the set of configuration parameters of the virtual cell. The communications manager 820 is capable of, configured to, or operable to support a means for receiving a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

By including or configuring the communications manager 820 in accordance with examples as described herein, the device 805 may support techniques for improved communication reliability, reduced latency, and increased spectrum utilization efficiency resulting in longer battery life and improved user experience.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of bandwidth aggregation configuration for FSI as described herein, or the at least one processor 840 and the at least one memory 830 may be otherwise configured to, individually or collectively, perform or support such operations.

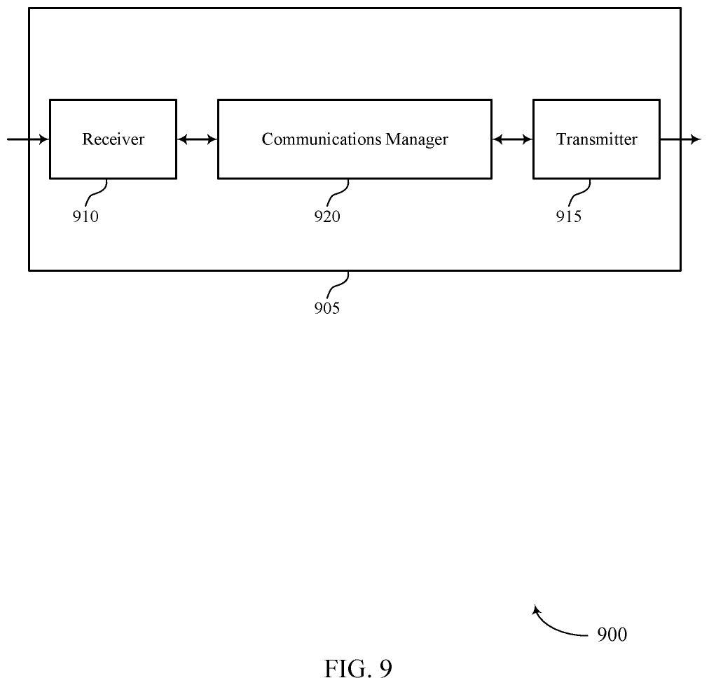

FIG. 9 shows a block diagram 900 of a device 905 that supports bandwidth aggregation configuration for FSI in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of bandwidth aggregation configuration for FSI as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting an indication of a set of configuration parameters of a virtual cell that supports communications for a UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers. The communications manager 920 is capable of, configured to, or operable to support a means for obtaining a capability message indicating a capability of the UE to support a subset of the set of configuration parameters of the virtual cell. The communications manager 920 is capable of, configured to, or operable to support a means for outputting a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

By including or configuring the communications manager 920 in accordance with examples as described herein, the device 905 (e.g., at least one processor controlling or otherwise coupled with the receiver 910, the transmitter 915, the communications manager 920, or any combination thereof) may support techniques for reduced signaling overhead, reduced processing, and increased spectrum utilization efficiency.

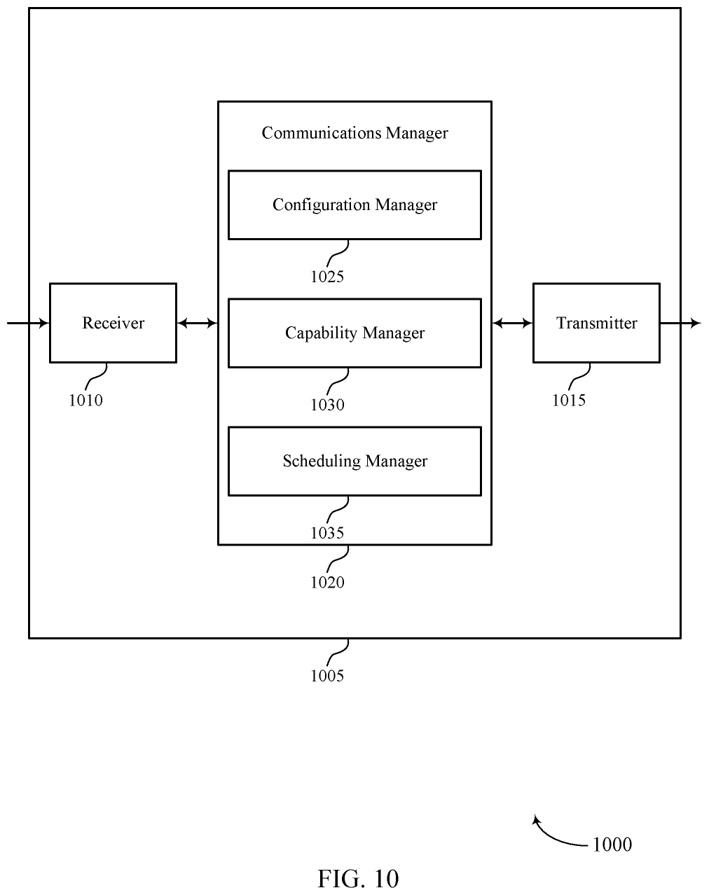

FIG. 10 shows a block diagram 1000 of a device 1005 that supports bandwidth aggregation configuration for FSI in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of bandwidth aggregation configuration for FSI as described herein. For example, the communications manager 1020 may include a configuration manager 1025, a capability manager 1030, a scheduling manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The configuration manager 1025 is capable of, configured to, or operable to support a means for outputting an indication of a set of configuration parameters of a virtual cell that supports communications for a UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers. The capability manager 1030 is capable of, configured to, or operable to support a means for obtaining a capability message indicating a capability of the UE to support a subset of the set of configuration parameters of the virtual cell. The scheduling manager 1035 is capable of, configured to, or operable to support a means for outputting a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

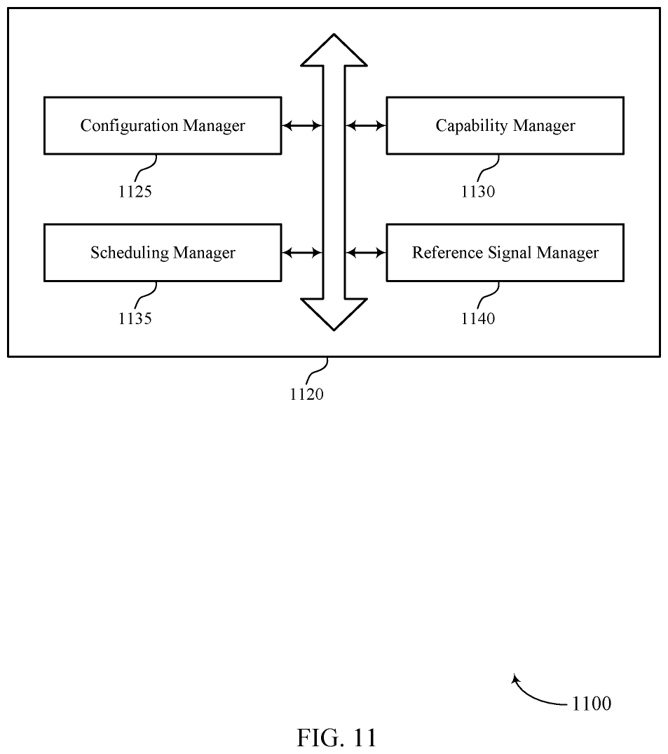

FIG. 11 shows a block diagram 1100 of a communications manager 1120 that supports bandwidth aggregation configuration for FSI in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of bandwidth aggregation configuration for FSI as described herein. For example, the communications manager 1120 may include a configuration manager 1125, a capability manager 1130, a scheduling manager 1135, a reference signal manager 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The configuration manager 1125 is capable of, configured to, or operable to support a means for outputting an indication of a set of configuration parameters of a virtual cell that supports communications for a UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers. The capability manager 1130 is capable of, configured to, or operable to support a means for obtaining a capability message indicating a capability of the UE to support a subset of the set of configuration parameters of the virtual cell. The scheduling manager 1135 is capable of, configured to, or operable to support a means for outputting a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

In some examples, to support outputting the indication of the set of configuration parameters of the virtual cell, the configuration manager 1125 is capable of, configured to, or operable to support a means for outputting an indication of a set of bandwidth aggregation states associated with the virtual cell, where a bandwidth aggregation state of the set of bandwidth aggregation states corresponds to a respective quantity of subband groups configured for the virtual cell, a respective frequency bandwidth configured for the communications with the UE via the virtual cell, a respective threshold quantity of subbands included in each subband group of the quantity of subband groups, a respective threshold frequency gap between adjacent subbands of a subband group, or any combination thereof.

In some examples, to support obtaining the capability message, the capability manager 1130 is capable of, configured to, or operable to support a means for obtaining an indication of a subset of the set of bandwidth aggregation states associated with the virtual cell that the UE supports.

In some examples, the set of resources corresponding to the scheduled one or more messages is based on a first frequency bandwidth of a first bandwidth aggregation state of the set of bandwidth aggregation states, a first quantity of subband groups associated with the first bandwidth aggregation state, or both. In some examples, the first bandwidth aggregation state is based on the subset of the set of configuration parameters of the virtual cell that the UE supports.

In some examples, to support outputting the indication of the set of configuration parameters of the virtual cell, the configuration manager 1125 is capable of, configured to, or operable to support a means for outputting an indication of a first subband group including a first subband of a first band of a first radio frequency spectrum band and a second subband of the first band.

In some examples, the first subband includes a second set of resources corresponding to a set of multiple component carriers of the first band. In some examples, the second set of resources is contiguous over the set of multiple component carriers.

In some examples, to support outputting the indication of the set of configuration parameters of the virtual cell, the configuration manager 1125 is capable of, configured to, or operable to support a means for outputting an indication of a first subband group including a first subband of a first band of a first radio frequency spectrum band and a second subband of a second band of the first radio frequency spectrum band.

In some examples, the first subband group includes a third subband corresponding to a frequency gap between the first band and the second band.

In some examples, to support outputting the indication of the set of configuration parameters of the virtual cell, the configuration manager 1125 is capable of, configured to, or operable to support a means for outputting an indication of a first subband group including one or more first subbands of a first band of a first radio frequency spectrum band and a second subband group including one or more subbands of a second band of the first radio frequency spectrum band.

In some examples, the reference signal manager 1140 is capable of, configured to, or operable to support a means for outputting a reference signal via a first subband of a first subband group, where the reference signal indicates timing information associated with both the first subband and a second subband of the first subband group.

In some examples, the reference signal manager 1140 is capable of, configured to, or operable to support a means for outputting, at a first transmit power and in accordance with a first spatial filter, a first reference signal via a first subband of a first subband group. In some examples, the reference signal manager 1140 is capable of, configured to, or operable to support a means for outputting, at a second transmit power and in accordance with the first spatial filter, a second reference signal via a second subband of the first subband group, where a difference between the second transmit power and the first transmit power satisfies a threshold.

In some examples, to support outputting the indication, the configuration manager 1125 is capable of, configured to, or operable to support a means for outputting the indication via a system information message or an RRC message.

In some examples, the one or more sub-component carriers include a fraction of a component carrier.

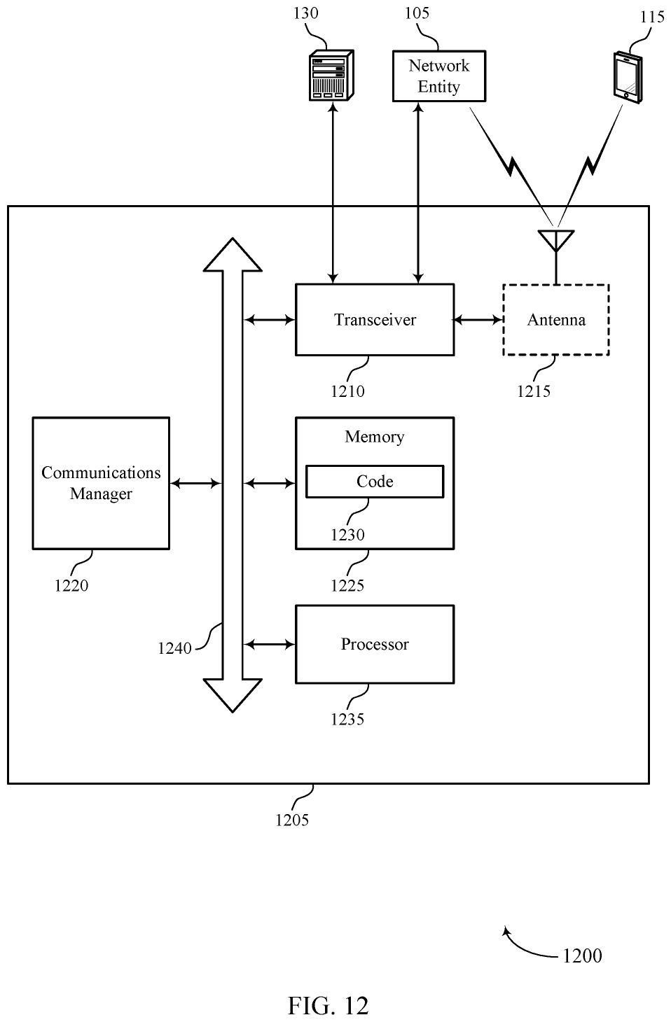

FIG. 12 shows a diagram of a system 1200 including a device 1205 that supports bandwidth aggregation configuration for FSI in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or any combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting bandwidth aggregation configuration for FSI). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting an indication of a set of configuration parameters of a virtual cell that supports communications for a UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers. The communications manager 1220 is capable of, configured to, or operable to support a means for obtaining a capability message indicating a capability of the UE to support a subset of the set of configuration parameters of the virtual cell. The communications manager 1220 is capable of, configured to, or operable to support a means for outputting a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports.

By including or configuring the communications manager 1220 in accordance with examples as described herein, the device 1205 may support techniques for improved communication reliability, reduced latency, and increased spectrum utilization efficiency resulting in longer battery life and improved user experience.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of bandwidth aggregation configuration for FSI as described herein, or the at least one processor 1235 and the at least one memory 1225 may be otherwise configured to, individually or collectively, perform or support such operations.

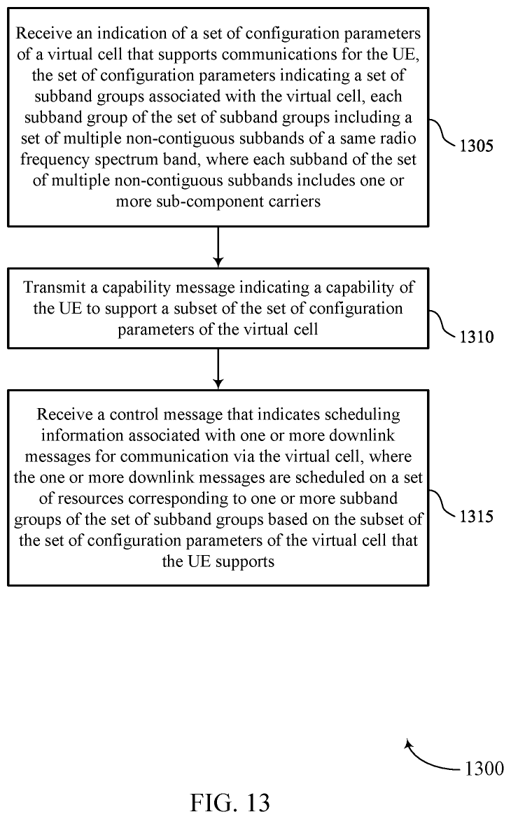

FIG. 13 shows a flowchart illustrating a method 1300 that supports bandwidth aggregation configuration for FSI in accordance with one or more aspects of the present disclosure. The operations of the method 1300 may be implemented by a UE or its components as described herein. For example, the operations of the method 1300 may be performed by a UE 115 as described herein with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving an indication of a set of configuration parameters of a virtual cell that supports communications for the UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers. The operations of 1305 may be performed in accordance with examples as disclosed herein. In some examples, aspects of the operations of 1305 may be performed by a configuration component 725 as described herein with reference to FIG. 7.

At 1310, the method may include transmitting a capability message indicating a capability of the UE to support a subset of the set of configuration parameters of the virtual cell. The operations of 1310 may be performed in accordance with examples as disclosed herein. In some examples, aspects of the operations of 1310 may be performed by a capability component 730 as described herein with reference to FIG. 7.

At 1315, the method may include receiving a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports. The operations of 1315 may be performed in accordance with examples as disclosed herein. In some examples, aspects of the operations of 1315 may be performed by a scheduling component 735 as described herein with reference to FIG. 7.

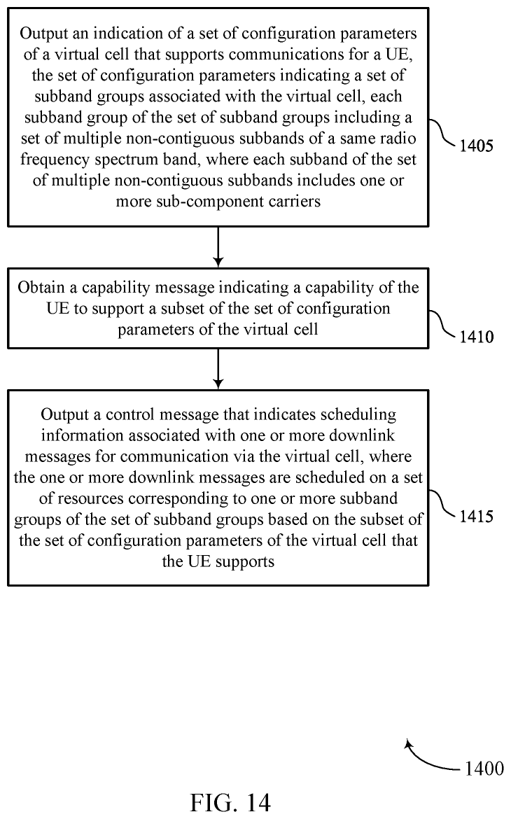

FIG. 14 shows a flowchart illustrating a method 1400 that supports bandwidth aggregation configuration for FSI in accordance with one or more aspects of the present disclosure. The operations of the method 1400 may be implemented by a network entity or its components as described herein. For example, the operations of the method 1400 may be performed by a network entity as described herein with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include outputting an indication of a set of configuration parameters of a virtual cell that supports communications for a UE, the set of configuration parameters indicating a set of subband groups associated with the virtual cell, each subband group of the set of subband groups including a set of multiple non-contiguous subbands of a same radio frequency spectrum band, where each subband of the set of multiple non-contiguous subbands includes one or more sub-component carriers. The operations of 1405 may be performed in accordance with examples as disclosed herein. In some examples, aspects of the operations of 1405 may be performed by a configuration manager 1125 as described herein with reference to FIG. 11.

At 1410, the method may include obtaining a capability message indicating a capability of the UE to support a subset of the set of configuration parameters of the virtual cell. The operations of 1410 may be performed in accordance with examples as disclosed herein. In some examples, aspects of the operations of 1410 may be performed by a capability manager 1130 as described herein with reference to FIG. 11.

At 1415, the method may include outputting a control message that indicates scheduling information associated with one or more messages for communication via the virtual cell, where the one or more messages are scheduled on a set of resources corresponding to one or more subband groups of the set of subband groups based on the subset of the set of configuration parameters of the virtual cell that the UE supports. The operations of 1415 may be performed in accordance with examples as disclosed herein. In some examples, aspects of the operations of 1415 may be performed by a scheduling manager 1135 as described herein with reference to FIG. 11.

The following provides an overview of aspects of the present disclosure:

Aspect 1: A method for wireless communications by a UE, comprising: receiving an indication of a set of configuration parameters of a virtual cell that supports communications for the UE, the set of configuration parameters indicating a set of subband groups associated with the virtual cell, each subband group of the set of subband groups comprising a plurality of non-contiguous subbands of a same radio frequency spectrum band, wherein each subband of the plurality of non-contiguous subbands comprises one or more sub-component carriers; transmitting a capability message indicating a capability of the UE to support a subset of the set of configuration parameters of the virtual cell; and receiving a control message that indicates scheduling information associated with one or more messages for communication via the virtual cell, wherein the one or more messages are scheduled on a set of resources corresponding to one or more subband groups of the set of subband groups based at least in part on the subset of the set of configuration parameters of the virtual cell that the UE supports.

Aspect 2: The method of aspect 1, wherein receiving the indication of the set of configuration parameters of the virtual cell comprises: receiving an indication of a set of bandwidth aggregation states associated with the virtual cell, wherein a bandwidth aggregation state of the set of bandwidth aggregation states corresponds to a respective quantity of subband groups configured for the virtual cell, a respective frequency bandwidth configured for the communications with the UE via the virtual cell, a respective threshold quantity of subbands included in each subband group of the quantity of subband groups, a respective threshold frequency gap between adjacent subbands of a subband group, or any combination thereof.

Aspect 3: The method of aspect 2, wherein transmitting the capability message comprises: transmitting an indication of a subset of the set of bandwidth aggregation states associated with the virtual cell that the UE supports.

Aspect 4: The method of any of aspects 2 through 3, wherein the set of resources corresponding to the scheduled one or more messages is based at least in part on a first frequency bandwidth of a first bandwidth aggregation state of the set of bandwidth aggregation states, a first quantity of subband groups associated with the first bandwidth aggregation state, or both, the first bandwidth aggregation state is based at least in part on the subset of the set of configuration parameters of the virtual cell that the UE supports.

Aspect 5: The method of any of aspects 1 through 4, wherein receiving the indication of the set of configuration parameters of the virtual cell comprises: receiving an indication of a first subband group comprising a first subband of a first band of a first radio frequency spectrum band and a second subband of the first band.

Aspect 6: The method of aspect 5, wherein the first subband comprises a second set of resources corresponding to a plurality of component carriers of the first band, the second set of resources is contiguous over the plurality of component carriers.

Aspect 7: The method of any of aspects 1 through 6, wherein receiving the indication of the set of configuration parameters of the virtual cell comprises: receiving an indication of a first subband group comprising a first subband of a first band of a first radio frequency spectrum band and a second subband of a second band of the first radio frequency spectrum band.

Aspect 8: The method of aspect 7, wherein the first subband group comprises a third subband corresponding to a frequency gap between the first band and the second band.

Aspect 9: The method of any of aspects 1 through 8, wherein receiving the indication of the set of configuration parameters of the virtual cell comprises: receiving an indication of a first subband group comprising one or more first subbands of a first band of a first radio frequency spectrum band and a second subband group comprising one or more subbands of a second band of the first radio frequency spectrum band.

Aspect 10: The method of any of aspects 1 through 9, further comprising: receiving a reference signal via a first subband of a first subband group, wherein the reference signal indicates timing information associated with both the first subband and a second subband of the first subband group.

Aspect 11: The method of any of aspects 1 through 10, further comprising: receiving, at a first transmit power and in accordance with a first spatial filter, a first reference signal via a first subband of a first subband group; and receiving, at a second transmit power and in accordance with the first spatial filter, a second reference signal via a second subband of the first subband group, wherein a difference between the second transmit power and the first transmit power satisfies a threshold.

Aspect 12: The method of any of aspects 1 through 11, wherein receiving the indication comprises: receiving the indication via a system information message or an RRC message.

Aspect 13: The method of any of aspects 1 through 12, wherein the one or more sub-component carriers comprise a fraction of a component carrier.

Aspect 14: A method for wireless communications by a network entity, comprising: outputting an indication of a set of configuration parameters of a virtual cell that supports communications for a UE, the set of configuration parameters indicating a set of subband groups associated with the virtual cell, each subband group of the set of subband groups comprising a plurality of non-contiguous subbands of a same radio frequency spectrum band, wherein each subband of the plurality of non-contiguous subbands comprises one or more sub-component carriers; obtaining a capability message indicating a capability of the UE to support a subset of the set of configuration parameters of the virtual cell; and outputting a control message that indicates scheduling information associated with one or more messages for communication via the virtual cell, wherein the one or more messages are scheduled on a set of resources corresponding to one or more subband groups of the set of subband groups based at least in part on the subset of the set of configuration parameters of the virtual cell that the UE supports.

Aspect 15: The method of aspect 14, wherein outputting the indication of the set of configuration parameters of the virtual cell comprises: outputting an indication of a set of bandwidth aggregation states associated with the virtual cell, wherein a bandwidth aggregation state of the set of bandwidth aggregation states corresponds to a respective quantity of subband groups configured for the virtual cell, a respective frequency bandwidth configured for the communications with the UE via the virtual cell, a respective threshold quantity of subbands included in each subband group of the quantity of subband groups, a respective threshold frequency gap between adjacent subbands of a subband group, or any combination thereof.

Aspect 16: The method of aspect 15, wherein obtaining the capability message comprises: obtaining an indication of a subset of the set of bandwidth aggregation states associated with the virtual cell that the UE supports.

Aspect 17: The method of any of aspects 15 through 16, wherein the set of resources corresponding to the scheduled one or more messages is based at least in part on a first frequency bandwidth of a first bandwidth aggregation state of the set of bandwidth aggregation states, a first quantity of subband groups associated with the first bandwidth aggregation state, or both, the first bandwidth aggregation state is based at least in part on the subset of the set of configuration parameters of the virtual cell that the UE supports.

Aspect 18: The method of any of aspects 14 through 17, wherein outputting the indication of the set of configuration parameters of the virtual cell comprises: outputting an indication of a first subband group comprising a first subband of a first band of a first radio frequency spectrum band and a second subband of the first band.

Aspect 19: The method of aspect 18, wherein the first subband comprises a second set of resources corresponding to a plurality of component carriers of the first band, the second set of resources is contiguous over the plurality of component carriers.

Aspect 20: The method of any of aspects 14 through 19, wherein outputting the indication of the set of configuration parameters of the virtual cell comprises: outputting an indication of a first subband group comprising a first subband of a first band of a first radio frequency spectrum band and a second subband of a second band of the first radio frequency spectrum band.

Aspect 21: The method of aspect 20, wherein the first subband group comprises a third subband corresponding to a frequency gap between the first band and the second band.

Aspect 22: The method of any of aspects 14 through 21, wherein outputting the indication of the set of configuration parameters of the virtual cell comprises: outputting an indication of a first subband group comprising one or more first subbands of a first band of a first radio frequency spectrum band and a second subband group comprising one or more subbands of a second band of the first radio frequency spectrum band.

Aspect 23: The method of any of aspects 14 through 22, further comprising: outputting a reference signal via a first subband of a first subband group, wherein the reference signal indicates timing information associated with both the first subband and a second subband of the first subband group.

Aspect 24: The method of any of aspects 14 through 23, further comprising: outputting, at a first transmit power and in accordance with a first spatial filter, a first reference signal via a first subband of a first subband group; and outputting, at a second transmit power and in accordance with the first spatial filter, a second reference signal via a second subband of the first subband group, wherein a difference between the second transmit power and the first transmit power satisfies a threshold.

Aspect 25: The method of any of aspects 14 through 24, wherein outputting the indication comprises: outputting the indication via a system information message or an RRC message.

Aspect 26: The method of any of aspects 14 through 25, wherein the one or mor sub-component carriers comprise a fraction of a component carrier.

Aspect 27: A UE comprising at least one processor, and at least one memory coupled with the at least one processors, with instructions stored in the at least one memory, the instructions being executable by the at least one processor, individually, or in any combination, to cause the UE to perform a method of any of aspects 1 through 13.

Aspect 28: A UE for wireless communications, comprising at least one means for performing a method of any of aspects 1 through 13.

Aspect 29: A non-transitory computer-readable medium storing code for wireless communications, the code comprising instructions executable by one or more processors to perform a method of any of aspects 1 through 13.

Aspect 30: A network entity comprising at least one processor, and at least one memory coupled with the at least one processors, with instructions stored in the at least one memory, the instructions being executable by the at least one processor, individually, or in any combination, to cause the network entity to perform a method of any of aspects 14 through 26.

Aspect 31: A network entity for wireless communications, comprising at least one means for performing a method of any of aspects 14 through 26.

Aspect 32: A non-transitory computer-readable medium storing code for wireless communications, the code comprising instructions executable by one or more processors to perform a method of any of aspects 14 through 26.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one processor; and
at least one memory coupled with the at least one processor, with instructions stored in the at least one memory, the instructions being executable by the at least one processor, individually or in any combination, to cause the UE to:
receive an indication of a set of configuration parameters of a virtual cell that supports communications for the UE, the set of configuration parameters indicating a set of subband groups associated with the virtual cell, each subband group of the set of subband groups comprising a plurality of non-contiguous subbands of a same radio frequency spectrum band, wherein each subband of the plurality of non-contiguous subbands comprises one or more sub-component carriers;
transmit a capability message indicating a capability of the UE to support a subset of the set of configuration parameters of the virtual cell; and
receive a control message that indicates scheduling information associated with one or more messages for communication via the virtual cell, wherein the one or more messages are scheduled on a set of resources corresponding to one or more subband groups of the set of subband groups based at least in part on the subset of the set of configuration parameters of the virtual cell that the UE supports.

2. The UE of claim 1, wherein, to receive the indication of the set of configuration parameters of the virtual cell, the instructions are executable by the at least one processor, individually or in any combination, to cause the UE to:
receive an indication of a set of bandwidth aggregation states associated with the virtual cell, wherein a bandwidth aggregation state of the set of bandwidth aggregation states corresponds to a respective quantity of subband groups configured for the virtual cell, a respective frequency bandwidth configured for the communications with the UE via the virtual cell, a respective threshold quantity of subbands included in each subband group of the quantity of subband groups, a respective threshold frequency gap between adjacent subbands of a subband group, or any combination thereof.

3. The UE of claim 2, wherein, to transmit the capability message, the instructions are executable by the at least one processor, individually or in any combination, to cause the UE to:
transmit an indication of a subset of the set of bandwidth aggregation states associated with the virtual cell that the UE supports.

4. The UE of claim 2, wherein the set of resources corresponding to the scheduled one or more messages is based at least in part on a first frequency bandwidth of a first bandwidth aggregation state of the set of bandwidth aggregation states, a first quantity of subband groups associated with the first bandwidth aggregation state, or both, and wherein the first bandwidth aggregation state is based at least in part on the subset of the set of configuration parameters of the virtual cell that the UE supports.

5. The UE of claim 1, wherein, to receive the indication of the set of configuration parameters of the virtual cell, the instructions are executable by the at least one processor, individually or in any combination, to cause the UE to:
receive an indication of a first subband group comprising a first subband of a first band of a first radio frequency spectrum band and a second subband of the first band.

6. The UE of claim 5, wherein the first subband comprises a second set of resources corresponding to a plurality of component carriers of the first band, and wherein the second set of resources is contiguous over the plurality of component carriers.

7. The UE of claim 1, wherein, to receive the indication of the set of configuration parameters of the virtual cell, the instructions are executable by the at least one processor, individually or in any combination, to cause the UE to:
receive an indication of a first subband group comprising a first subband of a first band of a first radio frequency spectrum band and a second subband of a second band of the first radio frequency spectrum band.

8. The UE of claim 7, wherein the first subband group comprises a third subband corresponding to a frequency gap between the first band and the second band.

9. The UE of claim 1, wherein, to receive the indication of the set of configuration parameters of the virtual cell, the instructions are executable by the at least one processor, individually or in any combination, to cause the UE to:
receive an indication of a first subband group comprising one or more first subbands of a first band of a first radio frequency spectrum band and a second subband group comprising one or more subbands of a second band of the first radio frequency spectrum band.

10. The UE of claim 1, wherein the instructions are further executable by the at least one processor, individually or in any combination, to cause the UE to:
receive a reference signal via a first subband of a first subband group, wherein the reference signal indicates timing information associated with both the first subband and a second subband of the first subband group.

11. The UE of claim 1, wherein the instructions are further executable by the at least one processor, individually or in any combination, to cause the UE to:
receive, at a first transmit power and in accordance with a first spatial filter, a first reference signal via a first subband of a first subband group; and
receive, at a second transmit power and in accordance with the first spatial filter, a second reference signal via a second subband of the first subband group, wherein a difference between the second transmit power and the first transmit power satisfies a threshold.

12. The UE of claim 1, wherein, to receive the indication, the instructions are executable by the at least one processor, individually or in any combination, to cause the UE to:
receive the indication via a system information message or a radio resource control message.

13. The UE of claim 1, wherein the one or more sub-component carriers comprise a fraction of a component carrier.

14. A network entity, comprising:
at least one processor; and
at least one memory coupled with the at least one processor, with instructions stored in the at least one memory, the instructions being executable by the at least one processor, individually or in any combination, to cause the network entity to:
output an indication of a set of configuration parameters of a virtual cell that supports communications for a user equipment (UE), the set of configuration parameters indicating a set of subband groups associated with the virtual cell, each subband group of the set of subband groups comprising a plurality of non-contiguous subbands of a same radio frequency spectrum band, wherein each subband of the plurality of non-contiguous subbands comprises one or more sub-component carriers;
obtain a capability message indicating a capability of the UE to support a subset of the set of configuration parameters of the virtual cell; and
output a control message that indicates scheduling information associated with one or more messages for communication via the virtual cell, wherein the one or more messages are scheduled on a set of resources corresponding to one or more subband groups of the set of subband groups based at least in part on the subset of the set of configuration parameters of the virtual cell that the UE supports.

15. The network entity of claim 14, wherein, to output the indication of the set of configuration parameters of the virtual cell, the instructions are executable by the at least one processor, individually or in any combination, to cause the network entity to:
output an indication of a set of bandwidth aggregation states associated with the virtual cell, wherein a bandwidth aggregation state of the set of bandwidth aggregation states corresponds to a respective quantity of subband groups configured for the virtual cell, a respective frequency bandwidth configured for the communications with the UE via the virtual cell, a respective threshold quantity of subbands included in each subband group of the quantity of subband groups, a respective threshold frequency gap between adjacent subbands of a subband group, or any combination thereof.

16. The network entity of claim 15, wherein, to obtain the capability message, the instructions are executable by the at least one processor, individually or in any combination, to cause the network entity to:
obtain an indication of a subset of the set of bandwidth aggregation states associated with the virtual cell that the UE supports.

17. The network entity of claim 15, wherein the set of resources corresponding to the scheduled one or more messages is based at least in part on a first frequency bandwidth of a first bandwidth aggregation state of the set of bandwidth aggregation states, a first quantity of subband groups associated with the first bandwidth aggregation state, or both, and wherein the first bandwidth aggregation state is based at least in part on the subset of the set of configuration parameters of the virtual cell that the UE supports.

18. The network entity of claim 14, wherein, to output the indication of the set of configuration parameters of the virtual cell, the instructions are executable by the at least one processor, individually or in any combination, to cause the network entity to:
output an indication of a first subband group comprising a first subband of a first band of a first radio frequency spectrum band and a second subband of the first band.

19. The network entity of claim 18, wherein the first subband comprises a second set of resources corresponding to a plurality of component carriers of the first band, and wherein the second set of resources is contiguous over the plurality of component carriers.

20. The network entity of claim 14, wherein, to output the indication of the set of configuration parameters of the virtual cell, the instructions are executable by the at least one processor, individually or in any combination, to cause the network entity to:
output an indication of a first subband group comprising a first subband of a first band of a first radio frequency spectrum band and a second subband of a second band of the first radio frequency spectrum band.

21. The network entity of claim 20, wherein the first subband group comprises a third subband corresponding to a frequency gap between the first band and the second band.

22. The network entity of claim 14, wherein, to output the indication of the set of configuration parameters of the virtual cell, the instructions are executable by the at least one processor, individually or in any combination, to cause the network entity to:
output an indication of a first subband group comprising one or more first subbands of a first band of a first radio frequency spectrum band and a second subband group comprising one or more subbands of a second band of the first radio frequency spectrum band.

23. The network entity of claim 14, wherein the instructions are further executable by the at least one processor, individually or in any combination, to cause the network entity to:
output a reference signal via a first subband of a first subband group, wherein the reference signal indicates timing information associated with both the first subband and a second subband of the first subband group.

24. The network entity of claim 14, wherein the instructions are further executable by the at least one processor, individually or in any combination, to cause the network entity to:
output, at a first transmit power and in accordance with a first spatial filter, a first reference signal via a first subband of a first subband group; and
output, at a second transmit power and in accordance with the first spatial filter, a second reference signal via a second subband of the first subband group, wherein a difference between the second transmit power and the first transmit power satisfies a threshold.

25. The network entity of claim 14, wherein, to output the indication, the instructions are executable by the at least one processor, individually or in any combination, to cause the network entity to:
output the indication via a system information message or a radio resource control message.

26. The network entity of claim 14, wherein the one or more sub-component carriers comprise a fraction of a component carrier.

27. A method for wireless communications by a user equipment (UE), comprising:
receiving an indication of a set of configuration parameters of a virtual cell that supports communications for the UE, the set of configuration parameters indicating a set of subband groups associated with the virtual cell, each subband group of the set of subband groups comprising a plurality of non-contiguous subbands of a same radio frequency spectrum band, wherein each subband of the plurality of non-contiguous subbands comprises one or more sub-component carriers;
transmitting a capability message indicating a capability of the UE to support a subset of the set of configuration parameters of the virtual cell; and
receiving a control message that indicates scheduling information associated with one or more messages for communication via the virtual cell, wherein the one or more messages are scheduled on a set of resources corresponding to one or more subband groups of the set of subband groups based at least in part on the subset of the set of configuration parameters of the virtual cell that the UE supports.

28. The method of claim 27, wherein receiving the indication of the set of configuration parameters of the virtual cell comprises:
receiving an indication of a set of bandwidth aggregation states associated with the virtual cell, wherein a bandwidth aggregation state of the set of bandwidth aggregation states corresponds to a respective quantity of subband groups configured for the virtual cell, a respective frequency bandwidth configured for the communications with the UE via the virtual cell, a respective threshold quantity of subbands included in each subband group of the quantity of subband groups, a respective threshold frequency gap between adjacent subbands of a subband group, or any combination thereof.

29. The method of claim 28, wherein transmitting the capability message comprises:
transmitting an indication of a subset of the set of bandwidth aggregation states associated with the virtual cell that the UE supports.

30. A method for wireless communications by a network entity, comprising:
outputting an indication of a set of configuration parameters of a virtual cell that supports communications for a user equipment (UE), the set of configuration parameters indicating a set of subband groups associated with the virtual cell, each subband group of the set of subband groups comprising a plurality of non-contiguous subbands of a same radio frequency spectrum band, wherein each subband of the plurality of non-contiguous subbands comprises one or more sub-component carriers;
obtaining a capability message indicating a capability of the UE to support a subset of the set of configuration parameters of the virtual cell; and
outputting a control message that indicates scheduling information associated with one or more messages for communication via the virtual cell, wherein the one or more messages are scheduled on a set of resources corresponding to one or more subband groups of the set of subband groups based at least in part on the subset of the set of configuration parameters of the virtual cell that the UE supports.
